(19) United States
(12) Patent Application Publication
(10) Pub. No.: US 2003/0042970 A1
(43) Pub. Date: Mar. 6, 2003

(54) Controllable reference voltage circuit with power supply isolation

(76) Inventor: Guy Harlan Humphrey, Fort Collins, CO (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 09/946,231

(22) Filed: Sep. 5, 2001

(51) Int. Cl. G05F 1/10

(52) U.S. Cl. 327/540

(57) ABSTRACT

A voltage reference circuit is provided, including a plurality of switching elements connected to a reference node, a voltage divider for providing a different voltage to each of the switching elements, and logic circuitry for selectively actuating the switching elements in response to a control signal provided to all of the switching elements.

### TECHNICAL FIELD

The subject matter disclosed here generally relates to active electrical circuits with a specific input and output function and, more particularly, to controllable reference voltage circuits.

### BACKGROUND

“MOS” is an acronym for Metal Oxide Semiconductor. As the name implies, MOS devices are formed using metal conductors, oxide insulators, and “semiconductors.” Semiconductors are crystalline materials having electrical properties between that of a conductor and an insulator. The conductivity of semiconductor material can be precisely controlled in a process called “doping” where a small amount of “dopant” is added to an otherwise pure, or “intrinsic,” semiconductor material. Doping leaves behind mobile, charged carriers for conducting electricity in the otherwise electrically-neutral semiconductor crystal lattice. When intrinsic semiconductor materials are doped so as to add negative charge carriers to the lattice, the material is referred to as an “n-type,” or donor “extrinsic” semiconductor, while the addition of positive carriers creates a “p-type,” acceptor material.

A “transistor” is one particular type of semiconductor device that is noteworthy for its ability to operate as an electrical switch, resistor, or amplifier, depending upon its configuration. There are two basic types of transistors, bipolar (or junction) transistors and field-effect transistors (“FETs”). Although equivalent digital circuits can be created using either transistor technology, FET technology is often preferred and will be used for the various examples described here.

The term “field-effect” is related to the application of an “electromotive field,” or voltage, to a “gate” terminal connected near the “junction” of the p-type and n-type materials. This gate voltage controls the size of a conductive “channel” through which electrons flow through as they pass from the “source” terminal to the “drain” terminal, or vice versa. Consequently, the gate voltage can be used to control the source-drain current through the channel in an FET.

Metal-oxide FETs, or “MOSFETs,” have an additional layer of a non-conductive oxide material (such as silicon dioxide) that insulates the gate terminal from the channel. Consequently, the gate current is very small regardless of the applied voltage so that circuits using MOSFETs can be made to consume, or “dissipate,” very little power. MOSFETs are characterized by their mode of operation and whether the channel is made from an n- or p-type semiconductor material. “Depletion-mode” operation occurs when the gate-source voltage (between the gate and source terminals) is used to deplete the channel of free carriers so as to reduce the size of the conductive channel and increase its resistance. In contrast, “enhancement-mode” operation occurs when the gate voltage is chosen to increase the size of the channel and thus decrease the source-drain resistance. Enhancement-mode MOSFETs are generally preferred, however, because the device will be normally “off” (i.e., the source drain resistance will be high) when the gate voltage falls below a certain “threshold value.”

Nonetheless, even when the gate voltage is low enough to turn “off” an enhancement-mode MOSFET, the resistance between the source and drain terminals is still generally not large enough to adequately prevent current from flowing between the source and drain under a large source-drain voltage. Consequently, as shown in FIG. 1, a MOSFET 5 is typically arranged in a digital circuit 10 with a resistor Rd, where G, D, S refer to the gate, source, and drain terminals. In addition, the source terminal is usually grounded in order to provide a reference voltage (of zero volts) with regard to the applied voltage at the drain Vdd.

In FIG. 1, the broken line inside the MOSFET 5 indicates that the transistor operates in enhancement mode and is therefore normally off (when Vin is zero). It will also be noted the source and substrate terminals are internally connected in the MOSFET symbol that is used in FIG. 1. However, depletion-mode and/or enhancement-mode MOSFETs with external and/or no connections between the source and substrate terminals may also be used. The direction of the arrow indicates whether the source and drain are connected by an n-type inversion layer as shown in FIG. 1, or a p-type inversion layer where the arrow is reversed. The MOSFET 5 is also equivalently represented with the circular “envelope” removed.

In the circuit configuration shown in FIG. 1, the resistor Rd will act as a voltage reducer when the transistor is conducting (and current is flowing between the source and drain) so as to prevent the transistor from receiving large currents. Consequently, when an input voltage Vin that is larger than the threshold value is applied to the gate terminal G, current will flow through Rd to create a corresponding low output voltage Vout near the gate terminal. Similarly, when input voltage Vin is removed, Vout will return to nearly the value of Vdd. For gate voltages that are between the threshold voltage and ground, the device will partially conduct, and thus act essentially as a variable resistor.

The direction of the source drain current will depend upon the polarity of the applied voltages as is well known in the art. However, since the output voltage, Vout, is opposite to the input voltage, Vin, this simple digital circuit is called an “inverter.” Of course, “on” and “off” are relative terms that depend on the configuration of the applied voltages. Therefore, switching from any state to the another state is often more-generally referred to as “actuating” from an “asserted” state to a “deasserted” state.

As discussed in Demassa et al., “Digital Integrated Circuits,” Chapter 16 (John Wiley & Sons 1996) and incorporated by reference here, the MOSFET 5 has a parasitic capacitance between the terminals for Vin and Vout. “Capacitance” refers to the ability of a conductor to store electric charge. “Parasitic” is used to refer to the inherent, and often undesirable, nature of this characteristic. More specifically, the time that is required in order to actuate a MOSFET is limited by how quickly this stored charge can be dissipated.

However, parasitic capacitance can also be advantageous in certain situations. For example, Vin may be subject to high frequency variations caused by electrical noise in the environment surrounding the circuit 10. If the parasitic capacitance of the MOSFET 5 is high enough, it will not actuate in response to this high frequency noise. Thus, the inherent capacitance of the MOSFET can used to create a low-frequency filter to minimize, or “attenuate,” the noise that would otherwise pass from Vin to Vout.

The resistor Rd in FIG. 1 is referred to as a “passive load” because its power-consumption effect on the circuit does not change. FIG. 2 illustrates another inverter configuration 20 where the passive resistor Rd is replaced with another n-type enhancement MOSFET 5 that actuates, and thus provides full resistance, when Vdd is high. This second digital circuit configuration for an inverter shown in FIG. 2 is generally preferred because it is smaller and easier to fabricate than the one shown in FIG. 1.

FIG. 3 illustrates yet another embodiment of a conventional MOSFET inverter 30 including an (upper) p-type enhancement MOSFET 7 and a (lower) n-type enhancement MOSFET 5. The p-type enhancement-mode MOSFET 7 is “complimentary” to the n-type MOSFET 5 device in that all voltages and currents are reversed from the n-type device 5. Consequently, replacing one of the n-MOSFETS in the inverter 20 in FIG. 2 with a p-MOSFET creates a Complementary Metal-Oxide Semiconductor, or “CMOS,” inverter 30 where when one device is on, the other is off, and vice-versa. The CMOS inverter 30 is also represented here by the logical symbol shown in FIG. 4 which, for the sake of simplicity, is also identified with the numeral 30.

While both n-type and p-type MOSFET transistors have a relatively large resistance between source and drain when switched off, this resistance varies according to the applied source and drain voltages when the transistors are switched on. Single transistors are therefore not preferred for use as transmission gates for controlling the transfer of signals through a switch. Instead, the inputs and outputs of two of the CMOS inverters 30 shown in FIG. 3 can be connected in series to create the unidirectional “driver” 50 shown in FIG. 5. The driver 50 is also referred to as a “uni-directional CMOS transmission gate,” or “buffer.” Since there are two inverters in series, Vout in this device will follow Vin when the driver 50 is actuated.

FIG. 6 illustrates a bi-directional, full CMOS transmission gate, or “CMOS switch,” 60. However, unlike the cascaded inverters 50 shown in FIG. 5, the bi-directional switch 60 will propagate a delayed voltage signal from Vin to Vout, and in the opposite direction, from Vout to Vin, when the switch is actuated by Vdd. More specifically, when the gate of the p-type MOSFET 7 is grounded and the gate of the n-type MOSFET is at Vdd, the transmission gate 60 will act like a closed switch where Vin equals Vout. Conversely, when the gate of the p-type MOSFET 7 is at Vdd and the gate of the n-type MOSFET is grounded, the transmission gate 60 will act like an open switch that prevents signals from being conveyed across the switch. CMOS digital circuits, transmission gates, and propagation delays are also discussed in more detail in Demassa et al., “Digital Integrated Circuits” (John Wiley & Sons 1996) and which is entirely incorporated by reference here.

The CMOS inverter 30 shown in FIGS. 3 and 4 can be combined with other transistors to form new circuits that perform various logical operations. For example, FIG. 7 illustrates one example of a CMOS circuit 70 for implementing the “AND” binary logic operation which is true (e.g., Vout is high) only if all its arguments are true (Va and Vb are high). The AND circuit 70 includes a CMOS not-and, or “NAND,” circuit 75 that outputs to a inverter 30. Although the NAND circuit 70 has been illustrated with only two inputs and one output, the circuit 70 may also be configured with additional inputs and/or outputs as is known in the art. The corresponding symbol for a three-input AND gate is shown in FIG. 8 and, for the sake of simplicity, has also been identified with the numeral 70.

Integrated circuits often require at least one internal voltage that is different from the external voltage which is provided to the integrated circuit at the power supply input. The conventional approach for providing multiple voltage levels is to introduce the voltage divider circuit 90 shown in FIG. 9. The voltage divider circuit 90 includes a voltage source 93 connected to a voltage divider 95. The voltage divider 95 may be configured as a series of discrete resistance elements 97, including but not limited to discrete resistors, variable resistors, silicon resistance elements (such as n-well and/or p-well resistors), transistors, tapped resistors, potentiometers, and/or in other ways that are well known. A series current “i” passes through all of the resistance elements 97 in the voltage divider 95 and creates reference voltages Vref1 and Vref2 between different positions along the circuit 90. The reference voltages Vref1 and Vref2 have different values that are each less than the voltage of the source 93. For the sake of simplicity, the voltage divider circuit 90 is illustrated with a ground connection 99 from which the voltages Vref1 and Vref2 are measured. However, a floating reference voltage may also be used.

During testing of an integrated circuit, combinations of various voltage divider branches may be tested with the circuit in order to identify an optimum voltage level. When a desired combination is found, it is selected by either burning one or more fuses, or by adjusting a metal mask to permanently select the combination. However, such conventional techniques are quite inflexible since programming with fuses or metal masks is a one-time only event and cannot be modified should a different optimum voltage level be desired later. Another disadvantage to this approach is that a fuse is often blown before the optimum voltage is reached.

One way of addressing the inflexibility associated with programming an optimum voltage level with fuses or metal masks is to use transistor programmability. FIG. 10 illustrates one example of a conventional transistor programmable reference generator 100 copied from U.S. Pat. No. 5,504,447 to Egging, which is incorporated by reference here in its entirety. The voltage reference generator 100 includes a voltage source block 108 and a programmable divider block 106. The programmable divider block 106 comprises four switching transistors 140-143, four transistors configured to act as resistors 150-153, a voltage reference node (VREF) 160, a common node (VSS) 162, first through third nodes 170-172, and first through fourth inputs 180-183. The output of voltage reference generator 90 is taken from VREF node 160.

The eight transistors of the programmable divider block 106 are p-channel (as designated by the unfilled circular portion) and are sized according to a desired voltage drop across each of their source/drains. A voltage reference signal VREF is generated at VREF node 160 when a voltage is supplied by the voltage source block 108 to the programmable voltage divider block 106 at VREF node 160. The voltage reference signal VREF is essentially the intermediate voltage in a voltage divider circuit. This voltage divider circuit is formed when one or a combination of the transistor/resistors 150-153 are selected to establish a VREF node 160 to VSS node 162 branch. Resistor 114 and transistor 106 of the voltage source block 108 establish the VREF node 160 to Vcc branch. Voltage reference signal VREF is then the intermediate voltage between Vcc and Vss node 162.

The programmability of the voltage reference generator 100 results when switching transistors 140-143 are either turned off or on. Transistor/resistors 150-153 are selected either individually or in combination by proper voltage settings at the inputs 180-183. These inputs 180-183 are the voltage levels necessary to keep the switching transistors 140-143 in either the on state or the off state. When switching transistor 140 is in the on state, its corresponding transistor/resistor 150 will be bypassed. When turned on, the resistance through switching transistor 140 is such that it is essentially a conductor, and current will flow through switching transistor 140, shorting VREF node 160 to first node 170, rather than through transistor/resistor 150.

When the voltage level at first input 180 is such that it turns off switching transistor 140, a voltage drop will occur across transistor/resistor 150, since in its off state, switching transistor 140 is not conducting. In the embodiment shown, where switching transistor 180 is a p-channel device, it is off when the gate voltage is not more than a threshold voltage below the source voltage. Thus, a high voltage at first input 180 is sufficient to turn off switching transistor 140. The remaining transistor/resistors 151-153 are programmed in a similar fashion.

Through choosing various combinations of inputs 180-183, a wide range of resistance values maybe achieved by selecting individual transistor/resistors 150-153 or any combination of transistor/resistors 150-153, resulting in several different levels of reference signal VREF. For example, if the voltage level at first input 180 is such that switching transistor 140 is in its off state, and if the voltage levels at the other inputs 181-183 are such that switching transistors 141-143 are in the on state, then transistor/resistor 150 will be the only transistor/resistor enabled. If, however, the voltage levels at second and fourth inputs 181 and 183 are such that switching transistors 141 and 143 are turned off, and the voltage levels at first and third inputs 180 and 182 are such that switching transistors 140, 142 are turned on, then the resulting resistance will be the sum of the resistance values of transistor/resistor 151 and transistor/resistor 153, since their respective resistance values will be in series. Further, with regard to FIG. 10, VREF node 160 is also connected to each of the channels of transistor/resistors 150-153. In this configuration, the resistance values of transistor/resistors 150-153 can be modified to permit further variations of reference signal VREF.

The Egging programmable divider block 106 suffers from a variety of drawbacks. For example, the switching is accomplished by standalone transistors 140-143, rather than transmission gates, and a separate pin is required for controlling each of the four switching transistors 140-143. Furthermore, variations in VREF provided by the voltage source block 108 will adversely affect the operation of the programmable divider block 100.

### SUMMARY

These and other drawbacks of conventional technology are addressed here by providing a voltage reference circuit and method of generating a reference voltage, including a plurality of switching elements connected to a reference node, a voltage divider for providing a different voltage to each switching element, and means, such as digital circuitry, for selectively actuating the switching elements in response to a control signal provided to all of the switching elements. The circuit may also include a capacitance element arranged between the reference node and ground, and/or a test switch for preventing a series current through the voltage divider.

The actuating means may include at least one logic gate circuit for receiving the control signal and providing a switching signal to each of the switching elements. For example, each of the switching elements may include a transmission gate circuit and the logic gate circuit may include an AND gate circuit associated with each transmission gate circuit for providing the switching signal to the associated transmission gate. The logic gate circuit may further include an inverter gate circuit for receiving the switching gate signal from the associated AND gate circuit and provided an inverted switching signal to the associated transmission gate circuit.

### BRIEF DESCRIPTION OF THE DRAWINGS

The various embodiments will now be described with respect to the following figures, where the reference numerals have been consistently used to identify the same features in each of the drawings, and

FIG. 1 is a circuit diagram for a conventional n-type enhancement-mode MOSFET device;

FIG. 2 is a circuit diagram for a conventional MOSFET inverter;

FIG. 3 is a circuit diagram for a conventional CMOS inverter;

FIG. 4 is a symbol representing the logic provided by the circuits shown in FIGS. 2 and 3.

FIG. 5 is a circuit diagram for a conventional uni-directional CMOS transmission gate;

FIG. 6 is a circuit diagram for a conventional bi-directional CMOS transmission gate;

FIG. 7 is a circuit diagram for a conventional AND logic gate;

FIG. 8 is a symbol representing the logic provided by the circuit shown in FIG. 7;

FIG. 9 is a circuit diagram for a conventional voltage divider circuit;

FIG. 10 is circuit diagram for a conventional voltage reference generator; and

FIG. 11 is a circuit diagram for a controllable reference voltage circuit with power supply isolation.

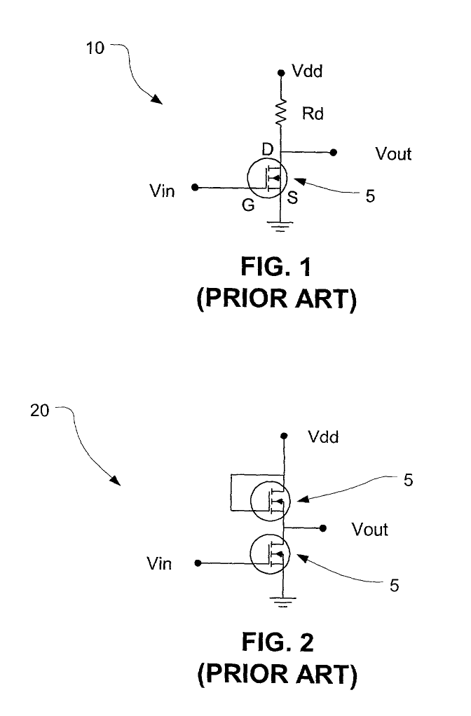

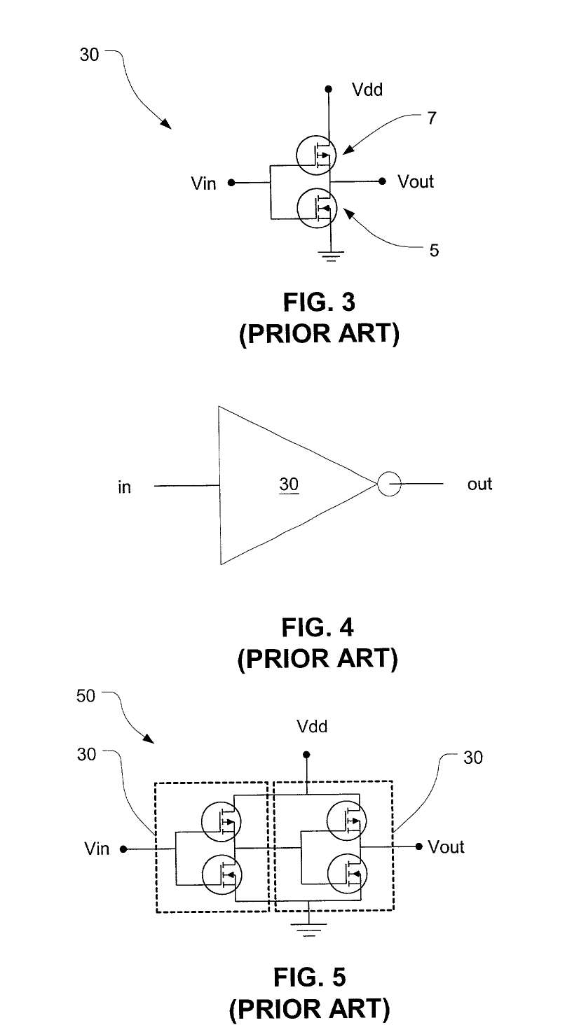

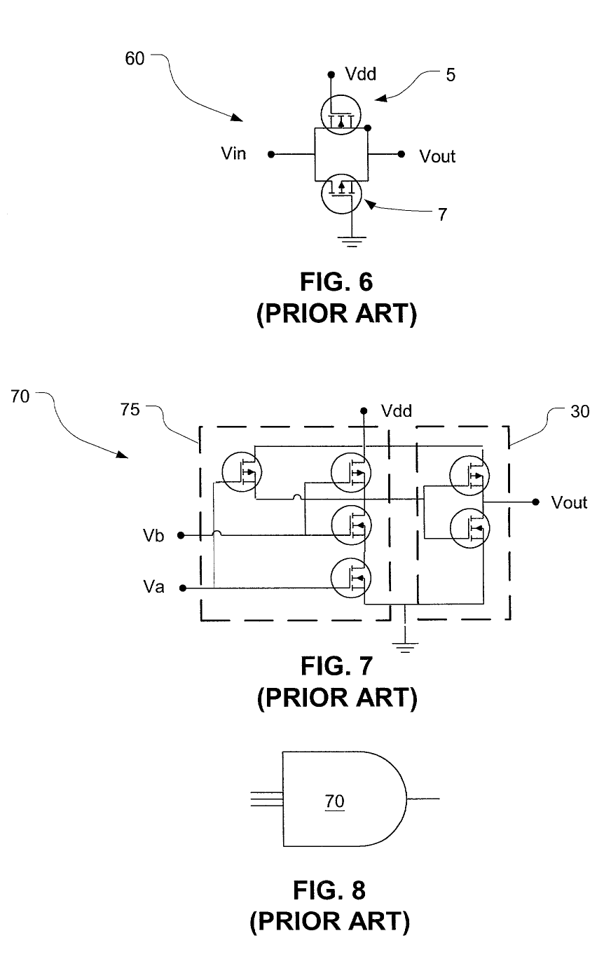

### DETAILED DESCRIPTION OF THE PREFERRED EMBODIMENTS

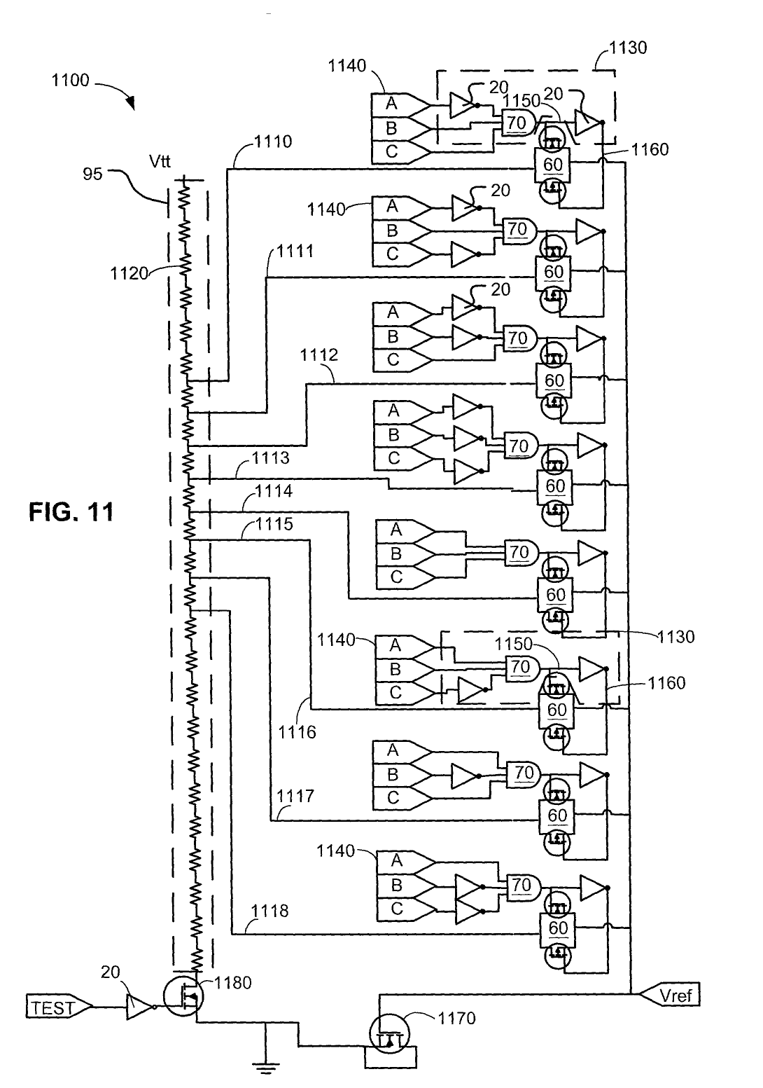

FIG. 11 is a circuit diagram for a controllable reference voltage circuit 1 100 with power supply isolation. The circuit 1100 includes a plurality of switching elements 60, which are connected to a reference node Vref The switching elements 60 are illustrated as bi-directional transmission gates. However, uni-directional transmission gates and/or other devices that can be used to open or close an electrical circuit may also be used. The circuit 100 includes a voltage divider 95 for providing a different voltage to each of the switching elements 60 via lines 1110-1118. The voltage divider 95 is preferably formed by a plurality of N-well resistors 1120 arranged in series with a voltage supply Vtt of 1.2 volts. This configuration results in a voltage drop of approximately 50 millivolts across each of the N-well resistors 1120.

However, the voltage divider 95 may be formed from any number of N-well resistors 1120 and/or a variety of other types of resistance elements. Furthermore, Vtt may be higher or lower than 1.2 volts.

Each of the transmission gate circuits 60 is associated with digital circuitry 1130 for selectively actuating the associated transmission gate circuit 60 in response to a control signal 1140 provided to each of the transmission gate 60. As illustrated in FIG. 11, a separate group of digital circuits 1130 is preferably provided for each of the transmission gate circuits 60. However, a combined set of multiple digital logic circuits 130 may also be provided with a separate output for each of the transmission gate circuits 60.

As illustrated in FIG. 11, the control signal 1140 is preferably a 3-bit code that is decoded in order to provide a switching signal for actuating certain transmission gate circuits 60. For example, bits A, B, and C may be stored in a register, or other device, for providing the appropriate voltage levels to the digital circuitry 1130. However, appropriate digital circuitry 1130 may also be provided for use with control signals having fewer or greater than 3-bits, serial control signals, and/or analog control signals. Table I lists the output voltage at node Vref for the logical inputs to bits A, B, and C where Vcc is about 1.2 volts and there is a voltage drop of approximately 50 millivolts across each N-well resistor 1120.

TABLE I

| Vref | A | B | C |
|---|---|---|---|
| .9 | 0 | 1 | 1 |
| .85 | 0 | 1 | 0 |
| .8 | 0 | 0 | 1 |
| .75 | 0 | 0 | 0 |
| .65 | 1 | 1 | 0 |
| .6 | 1 | 0 | 1 |
| .55 | 1 | 0 | 0 |

Although only two sets of digital logic circuitry 1130 are shown by the dashed lines in FIG. 11, each transmission gate circuit 60 is associated with its own digital logic circuitry 1130. Each of the digital logic circuits 130 includes at least one logic gate for receiving the control signal 1140 and providing a switching signal 1150 to the associated transmission gate circuit 60. For the example illustrated in FIG. 11, the logic gate circuit includes an AND gate circuit 70. However, other logical configurations may also be used. In addition, each of the logic gate circuits included in the digital circuits 1130 also includes an inverter gate circuit 20 for receiving the switching signal 1150 from the associated AND gate circuit and providing an inverted switching signal 1160 to the associated transmission gate circuit 60.

A capacitive element 1170 is arranged between the reference node Vref and ground (or other power supply voltage). Since the transmission gates 60 have some resistance, this capacitive element 1170 creates a low (frequency) pass filter that reduces the power supply noise that would otherwise appear at the reference node Vref. As illustrated in FIG. 11, the capacitive element 1170 is preferably a single transistor having a capacitance of around one picofarad. However, the capacitive element 1170 may also be a discreet and/or variable capacitor of other sizes. Other low-pass and/or high-pass filter arrangements may also be used, including those with inductive elements. Other power supply voltages besides ground may also be used.

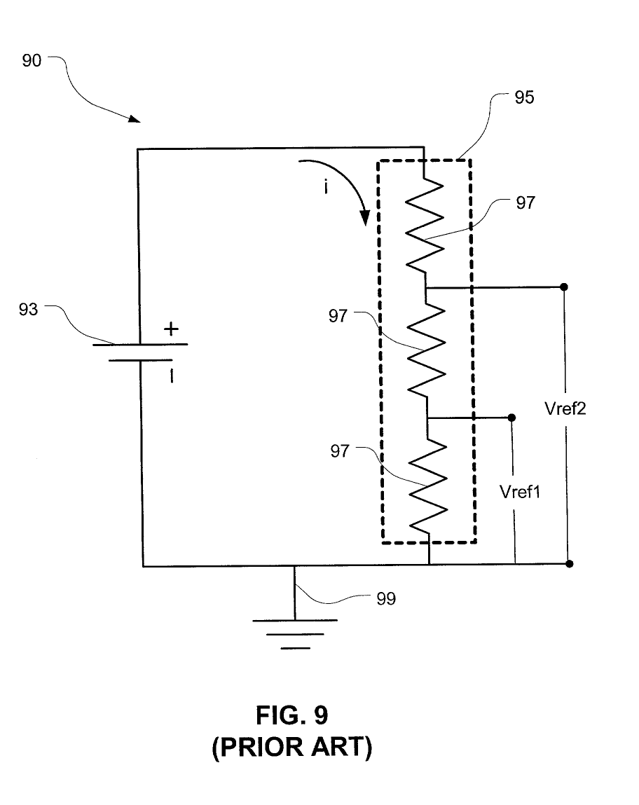

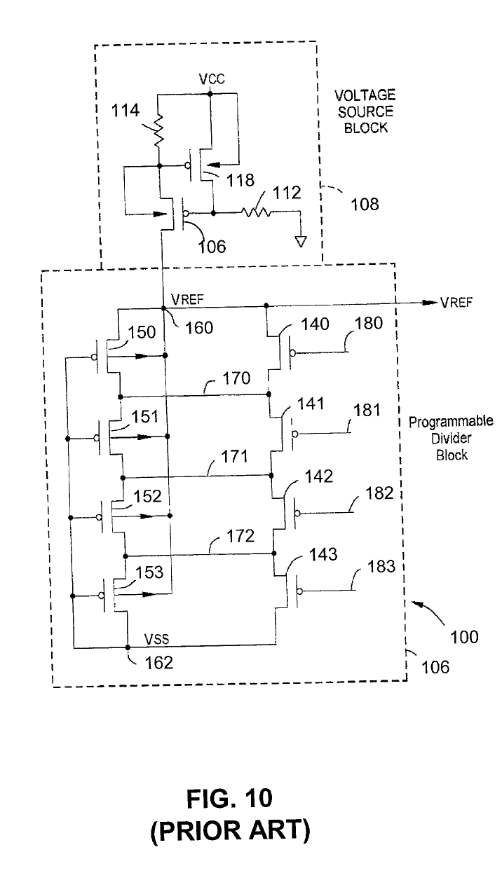

Also shown in FIG. 11 is a test switch element 1 180 arranged at the end of the voltage divider 95 for preventing a series current through the voltage divider 95. The test switch 1180 is preferably an n-FET transistor, as illustrated in FIG. 11. However, a variety of other electrical, electronic, and/or mechanical switches may also be used for preventing a series current I (FIG. 9) through all of the resistance elements 1120 when Vcc is applied to the voltage divider 95. By providing the appropriate test signal to the switch 1180 via the associated inverter circuit 20, the series or “static” current i through the voltage divider can be turned off in order to test for current leakage through the transmission gates 60 and/or to perform other tests.

It should be emphasized that the embodiments described above, and particularly any “preferred” embodiments, are merely examples of various implementations that have been set forth here to provide a clear understanding of various aspects of the invention. One of ordinary skill will be able to alter many of these embodiments without substantially departing from scope of protection defined solely by the proper construction of the following claims.

1. A voltage reference circuit, comprising:
a plurality of switching elements connected to a reference node;
a voltage divider for providing a different voltage to each switching element; and
means for selectively actuating the switching elements in response to a single control signal provided to all of the switching elements.

2. The voltage reference circuit recited in claim 1, further comprising a capacitance element connected to the reference node.

3. The voltage reference circuit recited in claim 2, wherein the capacitance element is connected between the reference node and ground.

4. The voltage reference circuit recited in claim 3, wherein the capacitance element includes a transistor.

5. The voltage reference circuit recited in claim 1, further comprising a test switch for preventing a series current through the voltage divider.

6. The voltage reference circuit recited in claim 4, wherein the test switch includes a transistor.

7. The voltage reference circuit recited in claim 1, wherein the voltage divider includes a plurality of n-well resistors.

8. The voltage reference circuit recited in claim 1, wherein each of the switching elements includes a transmission gate circuit.

9. The voltage reference circuit recited in claim 8, wherein the actuating means includes at least one logic gate circuit for receiving the control signal and providing a switching signal to each of the transmission gate circuits.

10. The voltage reference circuit recited in claim 9, wherein the at least one logic gate circuit includes an AND gate circuit associated with each transmission gate circuit for providing the switching signal to the associated transmission gate circuit.

11. The voltage reference circuit recited in claim 10, wherein the at least one logic gate circuit further includes an inverter gate circuit associated with each of the transmission gate circuits for receiving the switching signal from the associated AND gate circuit and providing an inverted switching signal to the associated transmission gate circuit.

12. A voltage reference circuit, comprising:
a plurality of transmission gate circuits with outputs connected to a reference node;
a plurality of resistance elements arranged in series for providing a different voltage to an input of each transmission gate circuit; and
digital circuitry for selectively actuating the transmission gate circuits in response to a single control signal provided to all of the transmission gates.

13. The voltage reference circuit recited in claim 12, further comprising a capacitive transistor connected to the reference node.

14. The voltage reference circuit recited in claim 13, wherein the capacitive transistor is connected between the reference node and ground.

15. The voltage reference circuit recited in claim 12, further comprising a switching transistor for stopping a series current through all of the resistive transistors.

16. The voltage reference circuit recited in claim 14, further comprising a switching transistor for stopping a series current through all of the resistive transistors.

17. The voltage reference circuit of claim 12, wherein the digital circuitry includes an AND gate circuit associated with each of the transmission gate circuits for receiving the control signal and providing a switching signal to the associated transmission gate circuit.

18. The voltage reference circuit recited in claim 17, wherein the digital circuitry further includes an inverter gate circuit associated with each of the transmission gate circuits and associated AND gate circuit for receiving the switching signal from the associated AND gate circuit and providing an inverted switching signal to the associated transmission gate circuit.

19. The voltage reference circuit recited in claim 16, wherein the digital circuitry includes an AND gate circuit associated with each of the transmission gate circuits for receiving the control signal and providing a switching signal to the associated transmission gate circuit.

20. The voltage reference circuit recited in claim 19, wherein the digital circuitry further includes an inverter gate circuit associated with each of the transmission gate circuits for receiving the switching signal from the associated AND gate circuit and providing an inverted switching signal to the associated transmission gate circuit.

21. A method of generating a reference voltage in a circuit having a plurality of transmission gate circuits connected to a reference node, the method comprising the steps of:
providing a different voltage to an input of each transmission gate circuit; and
selectively actuating the transmission gates in response to a single control signal provided to all of the transmission gates.

22. The method recited in claim 21, wherein the actuating step includes the steps of:
providing the control signal to an AND gate circuit associated with each transmission gate; and
providing an output of the AND gate circuit to the associated transmission gate.

23. The method recited in claim 22, wherein the actuating step further comprises the step of:
inverting an output of each AND gate circuit; and
providing the inverted output of the AND gate circuit to the associated transmission gate.

24. The method recited in claim 21, further comprising the step of filtering a reference signal from an actuated transmission gate.

25. The method recited in claim 23, further comprising the step of filtering a reference signal from an actuated transmission gate.
